(19) United States
(12) Patent Application Publication
(10) Pub. No.: US 2009/0287913 A1
(43) Pub. Date: Nov. 19, 2009

(54) APPARATUS AND METHOD FOR CONFIGURING SWITCHES, ROUTERS, AND OTHER CONFIGURABLE DEVICES

(75) Inventors: Scott A. Woods, Cave Creek, AZ (US); John A. Prall, Cave Creek, AZ (US); Jay W. Gustin, Scottsdale, AZ (US); Brian Polcyn, Pheonix, AZ (US)

Correspondence Address: Anthony Miologos;Honeywell International Inc., 101 Columbia Road, PO Box 2245, Morristown, NJ, 07962, US

(73) Assignee: Honeywell International Inc., Morristown, NJ (US)

(21) Appl. No.: 12/276,159

(22) Filed: Nov. 21, 2008

Related U.S. Application Data
(60) Provisional application No. 61/053,612, filed on May 15, 2008.

(51) Int. Cl. G06F 9/44

(52) U.S. Cl. 713/1

(57) ABSTRACT

A method includes receiving user input associated with configuration of a configurable device. The method also includes retrieving a template associated with the configurable device. The method further includes generating one or more configuration commands for the configurable device using the template and the user input. In addition, the method includes storing the commands and/or outputting the commands. The method could also include retrieving one or more rules associated with the configuration of the configurable device. The one or more rules could define at least one allowable configuration of the configurable device. Also, the user input could include one or more selections associated with one or more configuration options by a user, and the one or more rules could define the one or more configuration options available for selection by the user. The configurable device could represent a switch, a router, or other command-line configurable device.

### CROSS-REFERENCE TO RELATED APPLICATIONS

This application claims priority under 35 U.S.C. §119(e) to U.S. Provisional Patent Application No. 61/053,612 filed on May 15, 2008, which is hereby incorporated by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

This disclosure relates generally to network systems and more specifically to an apparatus and method for configuring switches, routers, and other configurable devices.

### BACKGROUND

Many networking and other devices can be configured via command line interfaces. For example, in the automation industry, switches and other types of configurable devices are quite common. These types of devices often require a considerable amount of expertise to configure. Moreover, these types of devices often have multiple options that can be configured. Correct configuration of these options is often required for basic implementation and functionality of a device. Also, these options could be used to optimize the devices for safety, security, and performance. Further, these types of devices are typically found in multiples, meaning multiple instances of each type of device could be used.

Advanced knowledge in networking topology and in the specifics of device commands is often needed to configure these types of devices. Each type of device also often has its own command language, and the command languages are not universal. To further complicate matters, each organization can have separate rules that apply to its own specific network topology or other circumstances. As a result, switch and other device configurations are typically costly and require expert resources that are not widely available.

In addition, each of these devices is often configured using a time-consuming command line-by-command line configuration. This type of manual configuration of the devices often results in mistakes, which not only represent a potential for loss of control but also can be extremely difficult to diagnose (even by individuals with considerable expertise). Even with traditional “copy and paste” mechanisms, each device often requires a degree of customization that can be just as time consuming and mistake prone.

### SUMMARY

This disclosure provides an apparatus and method for configuring switches, routers, and other configurable devices.

In a first embodiment, a method includes receiving user input associated with configuration of a configurable device. The method also includes retrieving a template associated with the configurable device. The method further includes generating one or more configuration commands for the configurable device using the template and the user input. In addition, the method includes storing the commands and/or outputting the commands.

In particular embodiments, the method also includes retrieving one or more rules associated with the configuration of the configurable device. The one or more rules could define at least one allowable configuration of the configurable device. Also, the user input could include one or more selections associated with one or more configuration options by a user, and the one or more rules could define the one or more configuration options available for selection by the user.

In other particular embodiments, retrieving the template includes retrieving multiple templates. One template is associated with multiple types of configurable devices including the configurable device, and another template is associated specifically with the configurable device.

In yet other particular embodiments, generating the one or more configuration commands includes selecting the one or more configuration commands from the template based on the user input and using one or more syntax rules together with one or more user selections to perform error checking and to form the one or more configuration commands.

In still other particular embodiments, the method also includes storing the user input. The method further includes, at a later time, receiving a second template associated with the configurable device and generating one or more additional configuration commands for the configurable device using the second template and the stored user input.

In a second embodiment, an apparatus includes a user interface configured to receive user input associated with configuration of a configurable device. The apparatus also includes a memory configured to store a template associated with the configurable device. In addition, the apparatus includes a processor configured to generate one or more configuration commands for the configurable device using the template and the user input.

In a third embodiment, a computer readable medium embodies a computer program. The computer program includes computer readable program code for receiving user input associated with configuration of a configurable device. The computer program also includes computer readable program code for retrieving a template associated with the configurable device. The computer program further includes computer readable program code for generating one or more configuration commands for the configurable device using the template and the user input. In addition, the computer program includes computer readable program code for storing the commands and/or outputting the commands.

In a fourth embodiment, a system includes a configurable device and a configuration tool. The configuration tool is configured to receive user input associated with configuration of the configurable device, retrieve a template associated with the configurable device, and generate one or more configuration commands for the configurable device using the template and the user input.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIGS. 1 and 2 illustrate example systems for configuring switches, routers, and other configurable devices according to this disclosure;

FIG. 3 illustrates an example industrial automation system according to this disclosure; and

FIG. 4 illustrates an example method for configuring switches, routers, and other configurable devices according to this disclosure.

### DETAILED DESCRIPTION

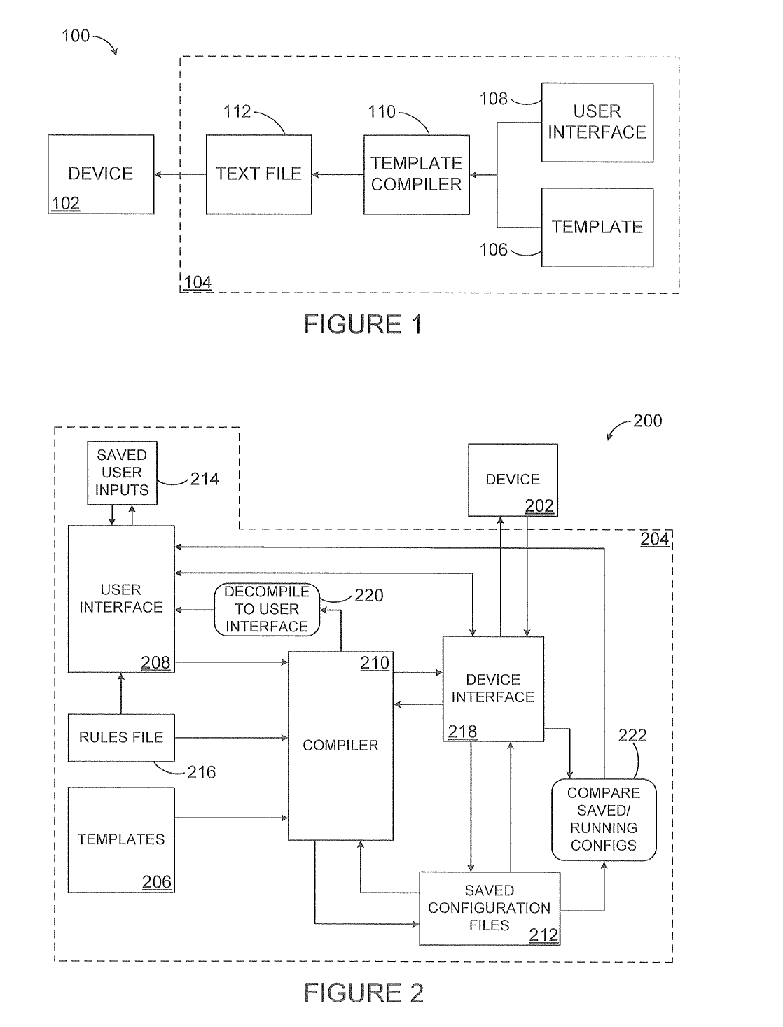

FIGS. 1 through 4, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIGS. 1 and 2 illustrate example systems 100 and 200 for configuring switches, routers, and other configurable devices according to this disclosure. The embodiments of the systems 100 and 200 shown in FIGS. 1 and 2 are for illustration only. Other embodiments of the systems 100 and 200 could be used without departing from the scope of this disclosure.

As shown in FIG. 1, the system 100 includes one or more configurable devices 102 and one or more configuration tools 104. Each configurable device 102 represents any suitable device that can be configured. For example, a configurable device 102 could represent a switch, router, firewall, wireless device, bridge, virtual private network (VPN) server, or other configurable device in a data network or other network. As a particular example, the configurable device 102 could represent a CISCO switch or other device that can be configured via a command line interface. It may be noted that each configurable device 102 could be used in any suitable manner, and multiple configurable devices 102 can have any suitable arrangement in a larger system or network.

Each configuration tool 104 facilitates the automation of the configuration of one or more configurable devices 102. In general, a configuration tool 104 can be used to allow expert knowledge to be packaged and distributed via, for example, a meta language mechanism. The packaged and distributed knowledge could then be used by non-technical personnel to configure one or more switches, routers, and other configurable devices 102.

The configuration tool 104 generally allows resource knowledge needed to configure a switch or other device 102 to be included in a meta language or other file referred to as a template 106. The template 106 contains the meta language or other information defining how a device 102 can be configured, which is often specified by expert or other personnel. Each template 106 includes any suitable information defining how a device can be configured. The configuration tool 104 could include any number of templates 106. For example, the configuration tool 104 could include a template 106 for each type of device 102 that can be configured using the configuration tool 104. Also, the templates 106 could be stored in any suitable manner, such as in a library or database.

A user interface 108 allows one or more users to input variables or other data for use with or in a template 106. For example, a keyboard, mouse, and display could be provided so that a user can provide configuration selections via drop-down menus or other input mechanisms. This may allow the user to define particular characteristics of the device 102 to be configured or to otherwise provide configuration-related data to the configuration tool 104.

The inputs to the user interface 108 can be provided by an end user (who is often not an expert in device configuration) and used to customize the configuration of the device 102. For example, user inputs could be used by the configuration tool 104 to select the appropriate configuration commands from a template 106 so that the device 102 can be configured appropriately. The user interface 108 includes any hardware, software, firmware, or combination thereof for receiving user inputs. Also, the user inputs could include any suitable data from a user related to the customization or configuration of a device.

A template compiler 110 receives a template 106 and any associated user inputs and compiles the template 106 to produce output commands for configuring a particular type of switch or other device 102. For example, the template compiler 110 could use the user inputs to select the appropriate commands to be issued to the device 102. The template compiler 110 could be customized to configure any suitable command-line configurable device. In this example, the template compiler 110 uses the template 106 and user input to produce a text file 112, which contains commands for configuring the device 102 in a specific manner. Note that the template compiler 110 could also apply the commands directly to the device 102 without generating an intermediate text file 112. The template compiler 110 includes any hardware, software, firmware, or combination thereof for generating configuration commands based on one or more templates and/or one or more user inputs. The template compiler 110 could, for example, be implemented as an executable software program.

The text file 112 includes a set of commands that can be used to configure a physical switch or other device 102. The text file 112 represents any suitable file containing commands to be applied to a device. While shown as a text file 112, the commands for configuring a device 102 could be stored in any suitable format.

In this example, templates 106 can be designed by experts or other knowledgeable resources. The templates 106 can be designed using a variety of available tools, as long as their contents (such as a meta language) are supported by the system 100. When new devices 102 or updates to existing devices 102 are released, new templates 106 can be created or existing templates 106 can be updated and easily distributed (without having to modify any executable code). This may allow, for example, users to rerun the configuration tool 104 using a saved configuration (user-provided variable values or other configuration data) and a new or updated template 106. This could require only a few mouse clicks or other input commands rather than having to rebuild a custom configuration. As a result, networking or other expertise can be encapsulated in the templates 106, while at the same time a template 106 can provide (i) a transparent configuration for those without extensive knowledge, (ii) a paper trail, and (iii) an easy mechanism for maintenance and distribution.

As shown in FIG. 2, the system 200 includes one or more configurable devices 202 and one or more configuration tools 204. Each configurable device 202 represents any suitable device to be configured, such as a switch, router, or other configurable device. Each configuration tool 204 facilitates the automation of the configuration of one or more configurable devices 202.

In this example, the configuration tool 204 includes one or more templates 206, a user interface 208, and a compiler 210. In some embodiments, the user interface 208 and the compiler 210 could collectively represent the executable portion of the configuration tool 204 in FIG. 2.

The user interface 208 allows, for example, someone with system product knowledge and little to no expertise regarding a device 202 being configured to provide enough information for the configuration tool 204 to configure the device 202. Information defining user inputs can be saved in one or more files 214, allowing users to easily store their selections. This may allow the same device 202 to be reconfigured later using a new or updated template 206 without requiring the user to reenter the user input.

The compiler 210 receives user inputs, rules in one or more rules files 216, and one or more templates 206. An individual, such as one with device expertise, can create a template 206 that contains the commands necessary to configure a device 202, such as on a command line basis. The compiler 210 uses syntax rules and logical functions to implement the necessary commands, based on the user input, to configure the device 202. The syntax rules ensure that any applied template 206 is syntactically correct from the perspective of the tool 204, thereby (among other things) providing error checking for the user. The compiler 210 also provides the connection between the templates 206 and the user inputs. Using the user inputs, the compiler 210 can select the appropriate configuration commands from the templates 206 and can apply the commands directly to the devices 202 (via suitable device interfaces 218) or generate separate configuration files 212 (such as text files). Note that a configuration file 212 can be saved by the user and applied to a device 202 at a later time. A saved configuration file 212 can also be de-compiled by the compiler 210 for presentation to a user via the user interface 208. This could be done using a function 220, which may be implemented by the compiler 210.

The configuration tool 204 can also be used to compare saved configuration files 212 to the current running configuration of a device 202. Among other things, this comparison allows for consistency checking and improved device maintenance/troubleshooting. This could be done using a function 222 in the tool 204. In addition, the compiler 210 may allow the use of a saved configuration file 212 or the configuration directly read from a device 202 to fill in options in the user interface 208.

In FIGS. 1 and 2, the templates 106, 206 represent files or other data structures typically created by device experts. The templates 106, 206 use logical functions, variables, and methods understood by the compilers 110, 210 to provide necessary configuration commands, which can be inferred by the user inputs. In this way, the templates 106, 206 can be built to encompass many or all possible device configurations. The templates 106, 206 could also allow experts or other personnel to limit the rules and possible device configurations to those that are “approved” or “recommended” (limiting the potential for incorrect configurations). Furthermore, field experts or other personnel may be able to modify templates 106, 206 or create their own templates 106, 206 that allow for greater customization on a per-site basis or even a per-device basis.

The templates 106, 206 may also allow for improved maintenance of device configurations. For example, as devices 102, 202 are updated and as configuration rules change, the recommended configurations of the devices 102, 202 may also change. Templates 106, 206 can be easily updated and redistributed, saving users from having to manually enter device commands and effectively reducing both risk and time spent. After receiving updated templates 106, 206, the users may be able to load their saved user interface selections (from one or more files 214) and generate new device configurations. This allows the users to quickly create updated configurations for the devices 102, 202 using the latest templates 106, 206 without having to manually reenter information required by the configuration tool 104, 204.

An additional advantage of the templates 106, 206 is that they can allow various levels of organization because of their nesting ability. For example, experts or other personnel can place commands common to multiple devices 102, 202 in a “common” template 106, 206, which can be injected into other device-specific templates 106, 206 by the compiler 110, 210 (such as via an “include” function). If changes affect multiple device types, the changes may be implemented in the common template 106, 206 rather than each individual device-specific template 106, 206. This can help to reduce or minimize syntax mistakes and unnecessary repetition.

The use of the templates 106, 206 to provide the configuration commands allows the configuration tools 104, 204 to be used with a wide variety of command-line configurable devices 102, 202 with minimal effort. The use of the rules files 216 provides another mechanism for expansion of the configuration tool 104, 204 to a wide variety of devices 102, 202. For example, the rules files 216 can allow experts or other personnel to easily add additional templates 106, 206, selectable options provided by the user interfaces 108, 208, and template functions or variables. Experts or other personnel can modify the rules files 216 without requiring the configuration tool 104, 204 to be recompiled or reinstalled. The rules files 216 can also be easily distributed along with updated templates 106, 206 without requiring redesign or redistribution of the configuration tool 104, 204.

In addition, the configuration tool 104, 204 can provide a multitude of ways to interface with each device 102, 202 (via the device interfaces 210). Possible communication interfaces include, but are not limited to, SNMP, Telnet, RS232 serial, FTP, and TFTP. This “in-tool interfacing” may allow users with little device knowledge to easily send the tool-generated configuration commands to a device 102, 202 and verify the results. Furthermore, any user that wishes to hand enter or modify applied commands can be provided with an interface to do so (at their own risk). Among other things, this can provide a mechanism to upgrade the firmware of many configurable devices 102, 202, eliminating the need for separate tools.

The various embodiments of the configuration tools 104, 204 shown and described above could be implemented in any suitable manner. For example, each of the configuration tools 104, 204 could be implemented on a computing device that includes one or more processors; one or more memories storing instructions and data used, generated, or collected by the processor(s); and one or more interfaces for communicating with one or more devices or over one or more networks. Each of the configuration tools 104, 204 could be implemented as a stand-alone device or incorporated into another device. Each of the configuration tools 104, 204 could be located in a position where one or multiple devices to be configured are accessible.

Although FIGS. 1 and 2 illustrate example systems 100 and 200 for configuring switches, routers, and other configurable devices, various changes may be made to FIGS. 1 and 2. For example, the functional division in each figure is for illustration only. Various components in FIGS. 1 and 2 could be combined, further subdivided, or omitted and additional components could be added according to particular needs.

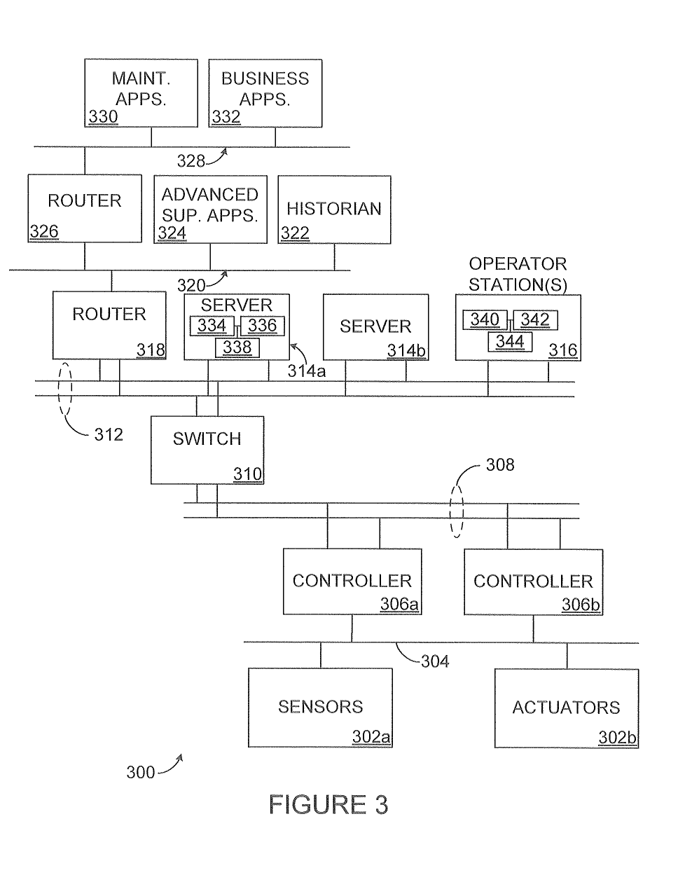

FIG. 3 illustrates an example automation system 300 according to this disclosure. The embodiment of the automation system 300 shown in FIG. 3 is for illustration only. Other embodiments of the automation system 300 may be used without departing from the scope of this disclosure.

In this example embodiment, the automation system 300 includes various components that facilitate production or processing of at least one product or other material, such as one or more sensors 302a and one or more actuators 302b. The sensors 302a and actuators 302b represent components that may perform any of a wide variety of functions. For example, the sensors 302a may measure a wide variety of characteristics in a process system, such as temperature, pressure, or flow rate. Also, the actuators 302b may alter a wide variety of characteristics in the process system and may represent components such as heaters, motors, or valves. The sensors 302a and actuators 302b may represent any other or additional components. Each of the sensors 302a includes any suitable structure for measuring one or more characteristics in a process system. Each of the actuators 302b includes any suitable structure for operating on or affecting conditions in a process system. Also, a process system may generally represent any system or portion thereof configured to process one or more products or other materials in some manner.

At least one network 304 is coupled to the sensors 302a and actuators 302b. The network 304 facilitates interaction with the sensors 302a and actuators 302b. For example, the network 304 could transport measurement data from the sensors 302a and provide control signals to the actuators 302b. The network 304 could represent any suitable network or combination of networks. As particular examples, the network 304 could represent an Ethernet network, an electrical signal network (such as a HART or FOUNDATION FIELDBUS network), a pneumatic control signal network, or any other or additional type(s) of network(s).

Two controllers 306a-306b are coupled to the network 304. The controllers 306a-306b may, among other things, use the measurements from the sensors 302a to control the operation of the actuators 302b. For example, the controllers 306a-306b could receive measurement data from the sensors 302a and use the measurement data to generate control signals for the actuators 302b. Each of the controllers 306a-306b includes any hardware, software, firmware, or combination thereof for interacting with the sensors 302a and controlling the actuators 302b. As a particular example, each of the controllers 306a-306b could represent a computing device running a MICROSOFT WINDOWS operating system.

Two networks 308 are coupled to the controllers 306a-306b. The networks 308 facilitate interaction with the controllers 306a-306b, such as by transporting data to and from the controllers 306a-306b. The networks 308 could represent any suitable networks or combination of networks. As particular examples, the networks 308 could represent a pair of Ethernet networks or a redundant pair of Ethernet networks, such as a FAULT TOLERANT ETHERNET (FTE) network from HONEYWELL INTERNATIONAL INC.

At least one switch 310 couples the networks 308 to two networks 312. The switch 310 may transport traffic from one network to another. The switch 310 may also block traffic on one network from reaching another network. The switch 310 includes any suitable structure for providing communication between networks, such as a HONEYWELL CONTROL FIREWALL (CF9) device. The networks 312 could represent any suitable networks, such as a pair of Ethernet networks or an FTE network.

Two servers 314a-314b are coupled to the networks 312. The servers 314a-314b perform various functions to support the operation and control of the controllers 306a-306b, sensors 302a, and actuators 302b. For example, the servers 314a-314b could log information collected or generated by the controllers 306a-306b, such as measurement data from the sensors 302a or control signals for the actuators 302b. The servers 314a-314b could also execute applications that control the operation of the controllers 306a-306b, thereby controlling the operation of the actuators 302b. In addition, the servers 314a-314b could provide secure access to the controllers 306a-306b. Each of the servers 314a-314b includes any hardware, software, firmware, or combination thereof for providing access to, control of, or operations related to the controllers 306a-306b. Each of the servers 314a-314b could, for example, represent a computing device running a MICROSOFT WINDOWS operating system.

One or more operator stations 316 are coupled to the networks 312. The operator stations 316 represent computing or communication devices providing user access to the servers 314a-314b, which could then provide user access to the controllers 306a-306b (and possibly the sensors 302a and actuators 302b). As particular examples, the operator stations 316 could allow users to review the operational history of the sensors 302a and actuators 302b using information collected by the controllers 306a-306b and/or the servers 314a-314b. The operator stations 316 could also allow the users to adjust the operation of the sensors 302a, actuators 302b, controllers 306a-306b, or servers 314a-314b. In addition, the operator stations 316 could receive and display warnings, alerts, or other messages or displays generated by the controllers 306a-306b or the servers 314a-314b. Each of the operator stations 316 includes any hardware, software, firmware, or combination thereof for supporting user access and control of the system 300. Each of the operator stations 316 could, for example, represent a computing device running a MICROSOFT WINDOWS operating system.

At least one router 318 couples the networks 312 to a network 320. The router 318 includes any suitable structure for providing communication between networks, such as a secure router or combination router/firewall. The network 320 could represent any suitable network, such as an Ethernet or FTE network.

Additional components are coupled to or communicate over the network 320. For example, a historian 322 could represent a device that collects various information from components of the system 300. This information can be stored for later use, such as in analyzing the performance of the system 300 or identifying problems or areas for improvement in the system 300. Advanced supervisory applications 324 could be used to manage and control the overall operation of the system 300. For example, the system 300 could be used in a processing or production plant or other facility, and the advanced supervisory applications 324 could represent applications used to control the plant or other facility. As particular examples, the advanced supervisory applications 324 could include applications such as enterprise resource planning (ERP), manufacturing execution system (MES), or any other or additional plant or process control applications. The historian 322 and the advanced supervisory applications 324 could be executed on or provided by any suitable device(s), such as server computers.

A router 326 couples the network 320 to a network 328. The router 326 includes any suitable structure for providing communication between two networks, such as a secure router or combination router/firewall. The network 328 could represent any suitable network(s), such as an Ethernet or FTE network. In this example, the router 326 may include, be used within, or otherwise associated with a Demilitarized Zone (DMZ). The DMZ may help to isolate the network 328 and the networks 308, 312, 320.

Additional components are coupled to or communicate over the network 328. For example, maintenance applications 330 could be used to schedule or verify maintenance of components in the system 300, such as maintenance of the process elements 302 or process equipment monitored or controlled by the system 300. As another example, business applications 332 could represent any suitable type of higher-level applications providing desired functionality in the system 300. The maintenance applications 330 and the business applications 332 could be executed on or provided by any suitable device(s), such as server computers.

In particular embodiments, the various servers and operator stations may represent computing devices. For example, each server could include one or more processors 334 and one or more memories 336 for storing instructions and data used, generated, or collected by the processor(s) 334. Each server could also include at least one network interface 338, such as one or more Ethernet interfaces. Also, each operator station could include one or more processors 340 and one or more memories 342 for storing instructions and data used, generated, or collected by the processor(s) 340. Each operator stations could also include at least one network interface 344, such as one or more Ethernet interfaces. While not shown, one or more operator stations could be coupled to each network 308, 312, 320, and 328 in the system 300.

In one aspect of operation, at least one of the operator stations or servers could implement a configuration tool (such as configuration tool 104 or 204). The configuration tool could be used, for example, to facilitate configuration of the switch 310, the router 318, and/or the router 326. As a particular example, a user could use one of the operator stations to interact with the configuration tool and provide inputs to the configuration tool. The configuration tool could use an appropriate template and the user inputs to generate commands used to configure the appropriate switch or router. The configuration tool could possibly store the commands in a text or other file and provide the commands to the appropriate switch or router.

In this way, templates can be used to encapsulate the knowledge necessary to configure a switch, router, or any other configurable devices in the system 300. Moreover, the templates, rules, or other data used by the configuration tool can be used to enforce “best practices” or desired configurations of the configurable devices. As particular examples, the configuration tool can be used to establish security settings, firewall settings, or other settings in a switch, router, or other configurable device. As another example, certain configurable devices (such as CISCO CATALYST 3750 SERIES switches) can be “stacked” or coupled together to function as a larger configurable device, and the configuration tool can be used to set up the individual configurable devices to function as a larger configurable device.

The following represents an example template that can be used by the configuration tool 104, 204 to configure a switch manufactured by CISCO SYSTEMS INC. This template could be used, for example, to configure the switch for use in a FAULT TOLERANT ETHERNET system.

```
!
! Copyright (c) Honeywell International Inc. All Rights Reserved
!
$BANNER
!
$REM Include the Cisco Biolerplate items that are present on all
switch types
$INCLUDE(“.\Cisco_Boilerplate. stml”)
$IF $NOT($SWITCHLEVEL == “Level 2”)
class-map match-all multilimit
  match access-group 101
class-map match-all giglimit
  match access-group 110
$ENDIF
...
!
$FOREACH $NODEINTERFACE
  $PASTE(“interface FastEthernet0/” + $ITERATIONELEMENT)
  description $GETNODEDESC($ITERATIONELEMENT)
$IF $OVLAN
  $PASTE(“switchport access vlan “ + $OVLAN)
$ENDIF
  switchport mode access
  no ip address
$INCLUDE(“.\Cisco 2950\” +
$GETNODETYPE($ITERATIONELEMENT) +
“_2950.stml”)
!
$ENDFOR
!
```

In this example, special rules, variables, and functions understood by the compiler have a ‘$’ as their first character. The $BANNER, $SWITCHLEVEL, $NODEINTERFACE, $ITERATIONELEMENT, and $OVLAN elements denote variables whose data values are provided by the user via the user interface. The $REM function is a method for creating comments in the tool. The $INCLUDE function takes a file path parameter and injects the text from the specified template, which may include any number of compiler commands and may even use the $INCLUDE function to inject commands from other templates themselves. The $IF, $NOT, and $ENDIF elements denote logical rules provided to the user to conditionally determine which commands should be sent to the device being configured. The $PASTE function allows users to combine information from variables with required command syntax to create complete device commands. The $FOREACH element provides a loop function. The $GETNODETYPE element is a function that takes a parameter to get information from a particular variable when there may be many of the same type. Other (non-comment) text above that is not proceeded by the ‘$’ character represent the commands to be provided to the device, assuming logical conditions are satisfied.

In this template, the $SWITCHLEVEL variable refers to the “level” of the device being configured in the automation system 300. For example, industrial sites often use a “Purdue Control System” model divided into multiple levels. Level 1 may, for example, serve process controllers 306a-306b and field input/output devices (such as sensors 302a or actuators 302b). Level 2 may, for example, support process control configuration databases, human-machine interfaces, and complex controls (this level could include the servers 314a-314b and the operator stations 316). Level 3 may, for example, support process control historians 322 and advanced supervisory applications 324. Level 4 may, for example, support process maintenance applications 330 and business applications 332. The “$SWITCHLEVEL==‘Level 2’” command here checks whether the device being configured is a switch coupled to a Level 2 FTE network (network 312).

The following represents a portion of an example XML rules file 216 for this type of switch manufactured by CISCO SYSTEMS INC.

```
!
! Copyright (c) Honeywell International Inc. All Rights Reserved
!
<Cisco_Catalyst>
        <Name>2960-24</Name>
        <TotalPorts>24</TotalPorts>
        <NumFEports>24</NumFEports>
        <Level1>true</Level1>
        <Level2>true</Level2>
        <Mixed>true</Mixed>
        <Split>true</Split>
        <Interface>
            <Name>FastEthernet</Name>
            <NumPort>24</NumPort>
        </Interface>
        <Interface>
            <Name>Gigabit</Name>
            <NumPort>2</NumPort>
        </Interface>
  <Template>
    <File>.\Templates\Cisco 2960\Cisco_2960.stml</File>
    <Level>Level1;Level2;Split;Mixed</Level>
    <Description>CISCO 2960</Description>
  </Template>
    </Cisco_Catalyst>
    <Cisco_Catalyst>
        <Name>2960-48</Name>
        <TotalPorts>48</TotalPorts>
        <NumFEports>48</NumFEports>
        <Level1>true</Level1>
        <Level2>true</Level2>
        <Mixed>true</Mixed>
        <Split>true</Split>
        <Interface>
            <Name>FastEthernet</Name>
            <NumPort>48</NumPort>
        </Interface>
        <Interface>
            <Name>Gigabit</Name>
            <NumPort>2</NumPort>
        </Interface>
  <Template>
    <File>.\Templates\Cisco 2960\Cisco_2960.stml</File>
    <Level>Level1;Level2;Split;Mixed</Level>
    <Description>CISCO 2960</Description>
  </Template>
    </Cisco_Catalyst>
```

The information provided in this rules file 216 determines the options available to the user via the user interface. It determines what possible configurations are allowed for the device, which templates may be applied, and where to find the appropriate templates.

Although FIG. 3 illustrates an example automation system 300, various changes may be made to FIG. 3. For example, the configuration tools 104 and 204 could be used in any other suitable system. As particular examples, the configuration tools 104 and 204 could use the example template provided above to configure a switch for use with an FTE network in any suitable systems. Example descriptions and uses of the FTE system are disclosed, for instance, in U.S. patent application Ser. Nos. 11/300,041; 11/316,252; and 11/888,090 (all of which are hereby incorporated by reference).

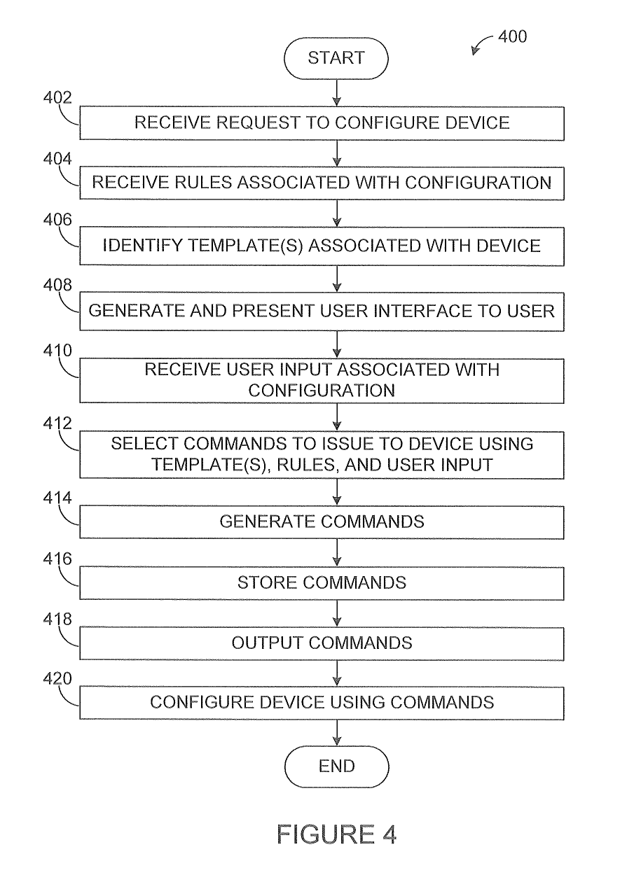

FIG. 4 illustrates an example method 400 for configuring switches, routers, and other configurable devices according to this disclosure. The embodiment of the method 400 shown in FIG. 4 is for illustration only. Other embodiments of the method 400 could be used without departing from the scope of this disclosure.

A request to configure a device is received at step 402. This could include, for example, a user invoking the configuration tool 104 or 204 and indicating a type of device to be configured. The type of device to be configured could be selected in any suitable manner, such as by using a menu system that includes different manufacturers of configurable devices and the names of the configurable devices that can be configured by the tool.

Rules associated with the configuration are received at step 404. This could include, for example, the configuration tool 104 or 204 retrieving a rules file based on the type of device to be configured, such as a rules file associated with a particular brand and model of switch or router.

At least one template associated with the device to be configured is identified at step 406. This could include, for example, the configuration tool 104 or 204 selecting a template based on the information contained in the rules file. Note that multiple templates could be identified here, such as one common template associated with multiple types of devices and a more specific template associated with the specific device to be configured.

A user interface is generated and presented to a user at step 408, and user inputs associated with the configuration are received at step 410. The user interface could include various options that can be selected by the user, such as using drop-down menus, checkboxes, or any other suitable input mechanisms. The rules file could be used to determine the options available to the user via the user interface.

The commands to be used to configure the device are selected at step 412 and generated at step 414. This could include, for example, the configuration tool 104 or 204 selecting the appropriate commands from the identified template(s) based on the desired configuration selected by the user. The rules file could be used to determine which possible configurations are allowed for the device being configured. This could also include the configuration tool 104 or 204 generating the commands by parsing the required command elements together, such as by inserting user options into the commands.

At this point, the generated commands could be used in any suitable manner. In this example, the commands are stored at step 416, output at step 418, and used to configure the device at step 420. It may be noted that the commands could also be output and used to configure the device without storing the commands in a long-term storage structure.

Although FIG. 4 illustrates an example method 400 for configuring switches, routers, and other configurable devices, various changes may be made to FIG. 4. For example, while shown as a series of steps, various steps in FIG. 4 could overlap, occur in parallel, occur in a different order, or occur multiple times.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The term “couple” and its derivatives refer to any direct or indirect communication between two or more elements, whether or not those elements are in physical contact with one another. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system, or part thereof that controls at least one operation. A controller may be implemented in hardware, firmware, software, or some combination of at least two of the same. The functionality associated with any particular controller may be centralized or distributed, whether locally or remotely.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
receiving user input associated with configuration of a configurable device;
retrieving a template associated with the configurable device;
generating one or more configuration commands for the configurable device using the template and the user input; and
at least one of: storing the commands and outputting the commands.

2. The method of claim 1, further comprising:
retrieving one or more rules associated with the configuration of the configurable device.

3. The method of claim 2, wherein the one or more rules define at least one allowable configuration of the configurable device.

4. The method of claim 2, wherein:
the user input comprises one or more selections associated with one or more configuration options by a user; and
the one or more rules define the one or more configuration options available for selection by the user.

5. The method of claim 2, wherein retrieving the template comprises one of:
retrieving the template from a location defined by the one or more rules;
retrieving the template based on user input; and
retrieving the template based on an identification of the configurable device

6. The method of claim 1, wherein retrieving the template comprises retrieving multiple templates, one template associated with multiple types of configurable devices including the configurable device, another template associated specifically with the configurable device.

7. The method of claim 1, wherein generating the one or more configuration commands comprises:
selecting the one or more configuration commands from the template based on the user input; and
using one or more syntax rules together with one or more user selections to perform error checking and to form the one or more configuration commands.

8. The method of claim 1, further comprising:
downloading a current configuration from the configurable device; and
at least one of: storing the current configuration and comparing the current configuration against a configuration associated with the one or more configuration commands.

9. The method of claim 1, further comprising:
storing the user input; and
at a later time, receiving a second template associated with the configurable device and generating one or more additional configuration commands for the configurable device using the second template and the stored user input.

10. An apparatus comprising:
a user interface configured to receive user input associated with configuration of a configurable device;
a memory configured to store a template associated with the configurable device; and
a processor configured to generate one or more configuration commands for the configurable device using the template and the user input.

11. The apparatus of claim 10, wherein the memory is further configured to store one or more rules associated with the configuration of the configurable device.

12. The apparatus of claim 11, wherein the one or more rules define at least one allowable configuration of the configurable device.

13. The apparatus of claim 11, wherein:
the user input comprises one or more selections associated with one or more configuration options by a user; and
the one or more rules define the one or more configuration options available for selection by the user.

14. The apparatus of claim 10, wherein the processor executes a compiler, the compiler configured to compile the template to generate the one or more configuration commands.

15. The apparatus of claim 10, wherein the processor is configured to generate the one or more configuration commands by:
selecting the one or more configuration commands from the template based on the user input; and
using one or more syntax rules together with one or more user selections to perform error checking and to form the one or more configuration commands.

16. The apparatus of claim 10, wherein:
the memory is further configured to store the user input; and
the processor is further configured to receive a second template associated with the configurable device and to generate one or more additional configuration commands for the configurable device using the second template and the stored user input.

17. A computer readable medium embodying a computer program, the computer program comprising:
computer readable program code for receiving user input associated with configuration of a configurable device;
computer readable program code for retrieving a template associated with the configurable device;
computer readable program code for generating one or more configuration commands for the configurable device using the template and the user input; and
computer readable program code for at least one of: storing the commands and outputting the commands.

18. The computer readable medium of claim 17, further comprising:
computer readable program code for retrieving one or more rules associated with the configuration of the configurable device;
wherein the one or more rules define at least one of: one or more allowable configurations of the configurable device, one or more configuration options available for selection by a user, and a location of the template to be used to configure to configurable device.

19. A system comprising:
a configurable device; and
a configuration tool configured to receive user input associated with configuration of the configurable device, retrieve a template associated with the configurable device, and generate one or more configuration commands for the configurable device using the template and the user input.

20. The system of claim 19, wherein the configurable device comprises one of: a switch, a router, a firewall, a wireless device, a bridge, and a virtual private network (VPN) server.
